(19) United States
(12) Patent Application Publication
(10) Pub. No.: US 2008/0152753 A1
(43) Pub. Date: Jun. 26, 2008

(54) Ejector Blade

(75) Inventors: Chih-Yu Chen, Taipei Hsien (TW); Jian-Guang Huang, Taipei Hsien (TW); Yu-Qing He, Taipei Hsien (TW); Chun-Yan Wu, Taipei Hsien (TW); Guo-Ning Liang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/615,814

(22) Filed: Dec. 22, 2006

(51) Int. Cl. B29C 45/40

(52) U.S. Cl. 425/556

(57) ABSTRACT

An ejector blade comprises a pin shaft and a safeguard. The pin shaft includes an enlarged circular head. The head is an integrally molded portion of the pin shaft. Furthermore, the pin shaft has a pillar part connected to the head and a blade part extending from the pillar part. Each side of the blade part defines an integrally molded support part thereon for supporting the thin blade part. The safeguard disposed in a core plate of a mold is cylindrically shaped with a diameter longer than the support part. The safeguard further defines a first axial passage for allowing the blade part to pass therethrough and a second axial passage for receiving the support part therein.

### BACKGROUND OF THE INVENTION

1. Field of the Invention

The present invention relates to a plastic injection mold, and more particularly to an ejector blade for ejecting plastic parts from the mold after a part having been formed.

2. The Related Art

Ejector blades are common parts of plastic injection molds for ejecting parts from a mold as the mold cavity is opened. A conventional ejector blade disclosed in U.S. Pat. No. 4,929,170 issued May 29, 1990 includes an elongated shank portion, a blade portion having a first end extending from one end of the shank portion, and a means releasably joining the shank portion to the blade portion at the end.

However, the elongated blade portion is flat and thin, so it may crack down when it ejects the parts from the mold. Therefore, a new-designed ejector blade to overcome the deficiency is required.

### SUMMARY OF THE INVENTION

Accordingly, an object of the present invention is to provide an ejector blade having a pin shaft and a safeguard. The pin shaft further includes an enlarged, circular head. The head is an integrally molded portion of the pin shaft. Furthermore, the pin shaft has a pillar part connected to the head, a blade part extending from the pillar part. The pillar part is cylindrically shaped with a diameter less than the head. The blade part extending from the pillar part is an elongated structure, generally flat and thin. Each side of the blade part defines an integrally molded support part thereon for supporting the thin blade part. The safeguard disposed in a core plate of a mold is cylindrically shaped with a diameter bigger than the support part. The safeguard further defines a first axial passage for allowing the blade part to pass therethrough and a second axial passage for receiving the support part therein. The first passage is slightly larger than the blade part, so that the movement between the blade part and the first passage is possible. Thus, the blade part can penetrate through the first passage and be exposed outside the other end of the safeguard for ejecting a formed plastic part from the mold.

The thin blade part is accommodated within the first passage as described above. Therefore, the safeguard encircles the thin blade part and prevents the blade part from bending or cracking down. Thus, the blade part can eject a formed plastic part from the mold easily.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of an ejector blade of the present invention;

FIG. 2 is a cross-sectional view of a pin shaft along the line II-II shown in FIG. 1;

FIG. 3 is a cross-sectional view of a safeguard along the line III-III shown in FIG. 1;

FIG. 4 is a perspective view of the safeguard;

FIG. 5 is a perspective assembled view of the ejector blade;

FIG. 6 is a cross-sectional view along the line VI-VI shown in FIG. 5;

FIG. 7 is a cross-sectional view of a plastic injection mold which comprises the ejector blade; and

FIG. 8 is an partial enlarged view of the encircled portion labeled VIII in FIG. 7.

### DETAILED DESCRIPTION OF THE PREFERRED EMBODIMENT

For facilitating understanding, like components are designated by like reference numerals throughout the embodiment of the invention as shown in the attached drawings.

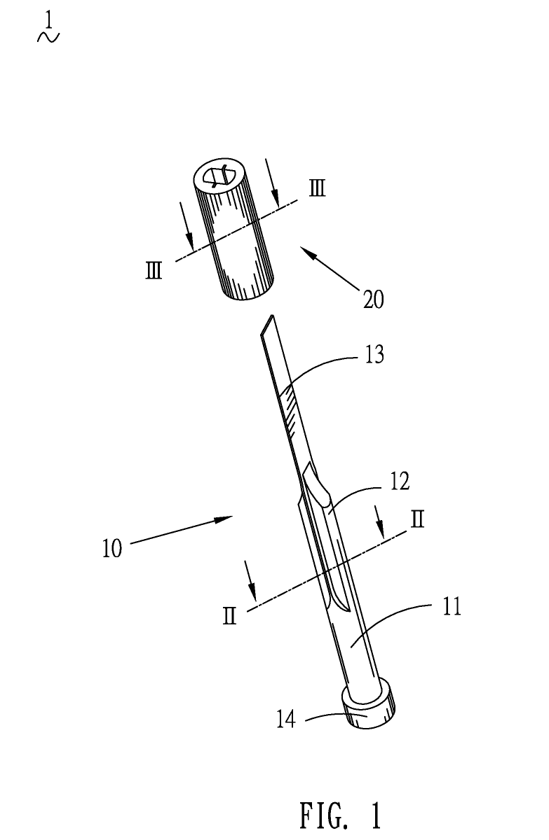

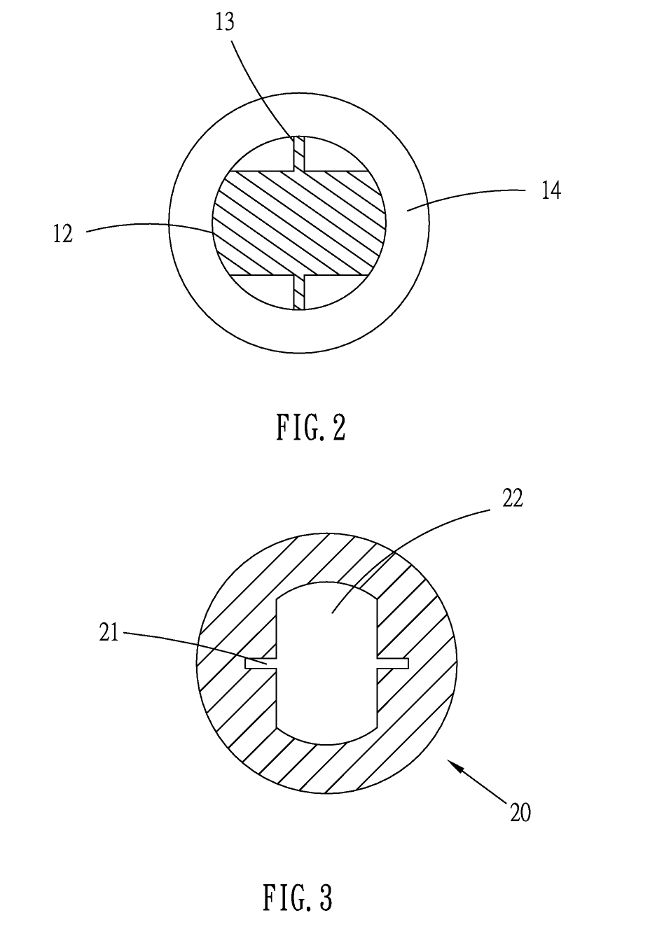

Now referring to FIG. 1 and FIG. 2, an ejector blade 1 according to the present invention includes a pin shaft 10 and a safeguard 20. The pin shaft 10 further includes an enlarged circular head 14 at one end which can be gripped in an appropriate location in a plastic injection mold as described below in more detail. The head 14 is preferably an integrally molded portion of the pin shaft 10. Alternatively, the head 14 may be connected to the shaft 10 by welding or other conventional fasteners, such as screws, bolts and the like. Furthermore, the pin shaft 10 has a pillar part 11 connected to the head 14, a blade part 13 extending from the pillar part 11. The pillar part 11 is cylindrically shaped with a diameter shorter than the head 14. The blade part 13 is an elongated structure, generally flat and thin, as shown in FIG. 1. Each side of the blade part 13 defines an integrally molded support part 12 thereon for supporting the thin blade part 13. The free end of the blade part 13 keeps a longer distance to the support part 12 for ensuring the blade part 13 having enough length to eject the plastic parts formed in the injection mold. The edge of the blade part 13 preferably keeps a shorter distance to the support part 12. Alternatively, the edge of the blade part 13 may keep a longer distance or has no distance to the support part 12.

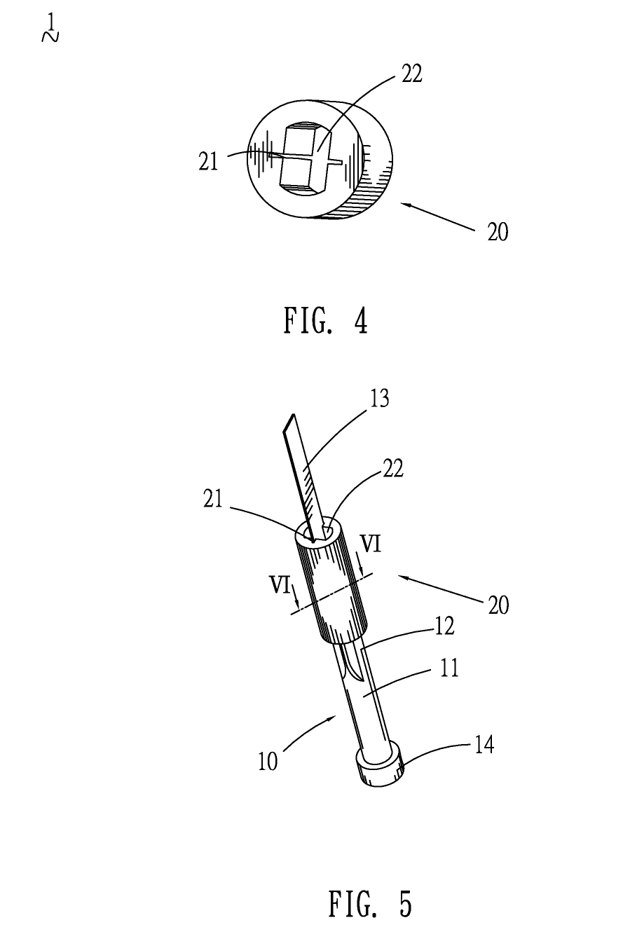

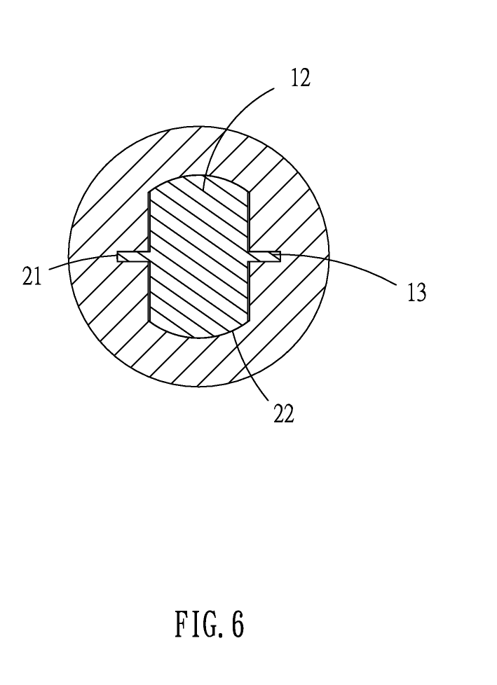

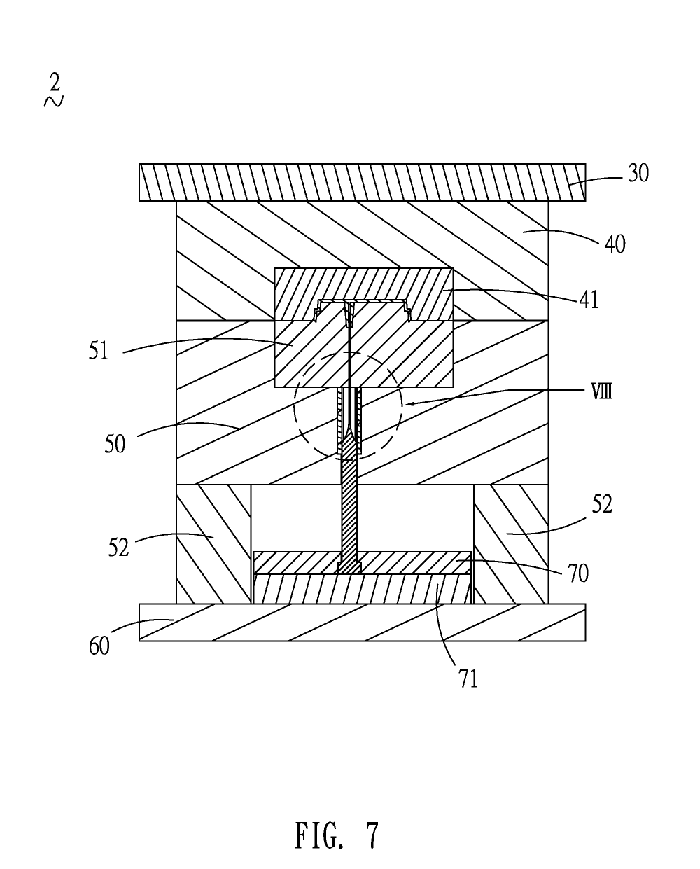

With reference to FIG. 1, FIG. 3 and FIG. 4, the safeguard 20 of the ejector blade 1 disposed in a core plate of a mold is cylindrically shaped with a diameter longer than the support part 12. The safeguard 20 further defines an axial first passage 21 for allowing the blade part 13 to pass therethrough and an axial second passage 22 for receiving the support part 12 therein. As shown in FIG. 5, FIG. 6 and FIG. 7, the first passage conforms to the shape of the blade part 13 for snugly fit the blade part 13. The first passage 21 is slightly larger than the blade part 13, so some movement between the blade part 13 and the first passage 21 is possible. Thus, the blade part 13 can drill through the first passage 21 and be exposed outside the other end of the safeguard 20 for ejecting a formed plastic part from the mold. Alternatively, the safeguard 20 can be in other shapes, e.g. cuboid, for being suitably disposed in the core plate, and can be shorter or longer according to the core plate of the mold.

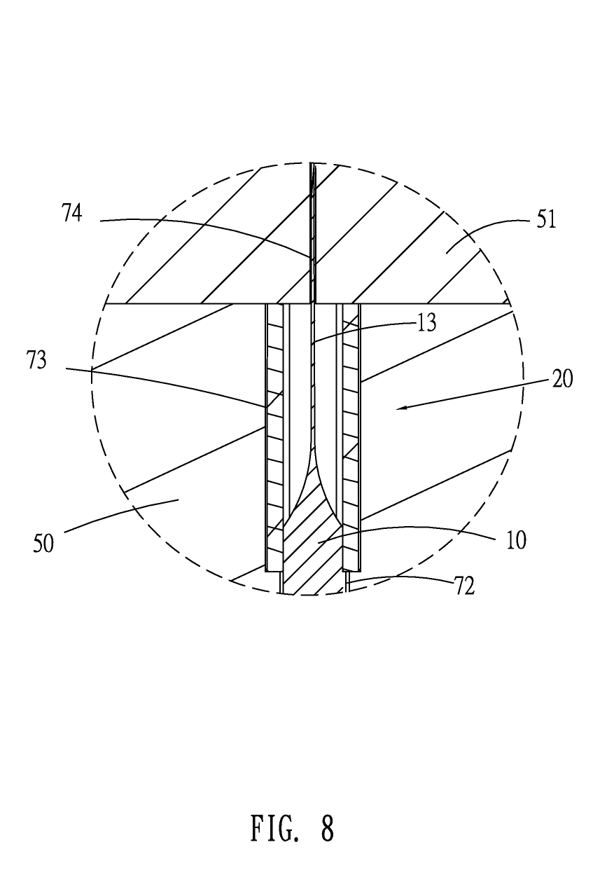

FIG. 7 and FIG. 8 show a cross-sectional view of the ejector blade 1 firmed in an injection mold 2. The injection mold 2 includes a top clamping plate 30, a cavity plate 40 fixed below the top clamping plate 30, a cavity insert 41 located in the cavity plate 40, a core plate 50 located below the cavity plate 40, a core insert 51 located in the core plate 50, a bottom clamping plate 60 fixed below the core plate 50, a plurality of support blocks 52 fixed between the core plate 50 and the bottom clamping plate 60. The core insert 51 and the cavity insert 41 cooperates to define a desired mold cavity for shaping parts. An ejector ret plate 70 and an ejector plate 71 are positioned between the core plate 50 and the ejector plate 71 is fixed below the ejector ret plate 70. Conventionally, the head 14 of the pin shaft 10 is secured in the ejector ret plate 70. More particularly, the core plate 50 defines a shaft hole 72 to allow the blade part 13 and the support part 12 formed on the blade part 13 to pass therethrough. The upper portion of the shaft hole 72 is enlarged and forms a safeguard-receiving cavity 73 for receiving the safeguard 20 therein. Correspondingly, the cavity insert 51 further forms a blade slot 74 to allow the blade part 13 pass through and stretch into the mold cavity for ejecting parts from the mold. Therefore, obviously, the blade slot 74, the safeguard-receiving cavity 73 and the shaft hole 72 are positioned in a straight line for receiving the straight ejector blade 1. The blade slot 74 conforms to the shape of the blade part 13, so it is much smaller than the safeguard-receiving cavity 73 which snugly fit the safeguard 20. As a result, the safeguard 20 is firmly held in the cavity plate 50 without any axial movement.

When the mold 2 is opened, the blade part 13 is moved upwards within the shaft hole 72 and the blade slot 74, and finally projects into the mold cavity to eject the parts out from the mold.

Part of the thin blade part 13 is accommodated within the first passage 21 as described above. Therefore, the safeguard 20 encircles the thin blade part 13 and prevents the blade part 13 from bending or cracking down.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An ejector blade for a plastic injection mold, comprising:
a pin shaft having an enlarged head at one end which can be gripped in an appropriate location in the injection mold, a pillar part being connected to the head, and a blade part extending from the pillar part; and
a safeguard having a first axial passage for allowing the blade part of the pin shaft to pass therethrough,
wherein the blade part drills through the safeguard within the first passage and encircled snugly by the safeguard.

2. The ejector blade as claimed in claim 1, each side of the blade part further comprising a support part formed thereon.

3. The ejector blade as claimed in claim 2, the safeguard further comprising a second axial passage for receiving the supporting part therein.

4. The ejector blade as claimed in claim 2, wherein the support part is integrally molded with the blade part.

5. The ejector blade as claimed in claim 2, wherein the free end of the blade part keeps a longer distance.

6. The ejector blade as claimed in claim 2, wherein the edge of the blade part keeps a shorter distance to the support part.

7. The ejector blade as claimed in claim 2, wherein the edge of the blade part keeps a longer distance to the support part.

8. The ejector blade as claimed in claim 2, wherein the edge of the blade part keeps no distance to the support part.

9. The ejector blade as claimed in claim 1, wherein the enlarged head of the pin shaft is secured in the ejector ret plate.

10. The ejector blade as claimed in claim 1, wherein the head of the pin shaft is an integrally molded portion of the pin shaft.

11. The ejector blade as claimed in claim 1, wherein the head of the pin shaft is connected to the pin shaft by screwing.

12. The ejector blade as claimed in claim 1, wherein the safeguard is positioned in a cavity plate of the plastic injection mold.
